(19) United States
(12) Patent Application Publication
(10) Pub. No.: US 2012/0099038 A1
(43) Pub. Date: Apr. 26, 2012

(54) LIQUID CRYSTAL DISPLAY DEVICE AND ELECTRONIC DEVICE USING THE SAME

(75) Inventors: Masahiro YOSHIGA, Chu-Nan (TW); Naoki SUMI, Chu-Nan (TW); Satoru TAKAHASHI, Chu-Nan (TW)

(73) Assignee: CHIMEI INNOLUX CORPORATION, Chu-Nan (TW)

(21) Appl. No.: 13/280,102

(22) Filed: Oct. 24, 2011

(30) Foreign Application Priority Data
Oct. 25, 2010 (JP) 2010-238670

(51) Int. Cl. G02F 1/133

(52) U.S. Cl. 349/33

(57) ABSTRACT

The invention provides a liquid crystal display device capable of assuring high transmittance or reflectance and displaying multicolor stably. The liquid crystal display device is provided with a plurality of pixels arranged in a matrix. Each pixel includes a memory circuit storing digital values representing a color to be displayed by the pixel, a digital-analog converter circuit converting the digital value stored in the memory circuit to a voltage corresponding to the color to be displayed, and a liquid crystal cell transmitting light with different wavelengths according to the voltage.

### CROSS REFERENCE TO RELATED APPLICATIONS

This Application claims priority of Japanese Patent Application No. 2010-238670, filed on Oct. 25, 2010, the entirety of which is incorporated by reference herein.

### BACKGROUND OF THE INVENTION

1. Field of the Invention

The present invention relates to a color liquid crystal display device having a plurality of pixels arranged in a matrix, and an electronic device thereof.

2. Description of the Related Art

Generally, a color liquid crystal display device comprises a display device using a color filter having a color layer, wherein light may pass therethrough to display multicolor, and a display device using the characteristic of a birefringence of a liquid crystal molecule to display multicolor. In the color liquid crystal display device which uses a color filter, the color filter of a specific color can absorb light within a wavelength band corresponding to a color component to generate colored light. However, because the color filter also absorbs light outside of the desired wavelength band, transmittance and/or reflectance may decrease depending upon the type liquid crystal display such as a transmissive type liquid crystal display device using transmissive light from a backlight configured at the back of the display device to perform displaying, a reflective type liquid crystal device using ambient light reflected by a reflector to perform displaying, or a transflective type liquid crystal device combing the structures of the transmissive type liquid crystal display device and the reflective type liquid crystal device to perform displaying.

On the other hand, in the color liquid crystal display device which uses the characteristic of the birefringence of a liquid crystal molecule, colored light can be obtained by optical retardation of light passing through a liquid crystal layer sandwiched between a pair of polarizers. Because the color filter is not utilized, high transmittance and/or reflectance can be obtained. Details about the color liquid crystal display device which uses the characteristic of the birefringence of a liquid crystal molecule is described in Japanese patent publish H6-095151 (patent document 1) and Japanese patent publish H11-190849 (patent document 2).

Patent document 1: Japanese patent publish H6-095151

Patent document 2: Japanese patent publish H11-190849

However, the color liquid crystal display device which uses the characteristic of the birefringence of a liquid crystal molecule varies display color in response to the orientation of the liquid crystal molecule controlled by the voltage applied to the liquid crystal layer, so that this kind of color liquid crystal display device is too sensitive to the variation of the applied voltage.

The invention provides a liquid crystal display device capable of assuring high transmittance and/or reflectance and displaying multicolor stably.

### BRIEF SUMMARY OF THE INVENTION

A detailed description is given in the following embodiments with reference to the accompanying drawings.

The invention provides a liquid crystal device provided with a plurality of pixels arranged in a matrix. Each pixel includes a memory circuit storing digital values representing a color to be displayed by the pixel, a digital-analog converter circuit converting the digital value stored in the memory circuit to a voltage corresponding to the color to be displayed, and a liquid crystal cell transmitting light with different wavelengths according to the voltage.

The liquid crystal device further includes a voltage source providing each pixel with the voltage corresponding to the color to be displayed by the pixel. The voltage source includes a plurality of voltage supply lines corresponding to each of a plurality of colors. The plurality of colors includes RGB colors

In an embodiment, each pixel has above 2 subpixels, and the memory circuit, the digital-analog converter circuit, and the liquid crystal cell are disposed in each subpixel.

In an example of the above embodiment, each pixel has 3 subpixels, and the digital-analog converter circuits of the 3 subpixels output voltages corresponding RGB colors, respectively.

In another example of the above embodiment, each pixel has 2 subpixels. The digital-analog converter circuit of the first subpixel outputs voltages corresponding to any two colors of the RGB colors, and the digital-analog converter circuit of the second subpixel outputs voltages corresponding a color mixed from the two colors and the other color of the RGB colors

In another embodiment, each pixel has 2 subpixels, and the liquid crystal cell is disposed in each subpixel but the memory circuit and the digital-analog converter circuit is shared by the 2 subpixels. The digital-analog converter circuit outputs voltages corresponding to any two colors of the RGB colors to one of the liquid crystal cells, and outputs a voltage corresponding the other color of the RGB colors to the other liquid crystal cell.

In the case where each pixel has above 2 subpixels, the liquid cells of the subpixels have different cell gaps. When applied with the same voltage the liquid cells with different cell gaps transmit light with different wavelengths.

In an embodiment, in a group formed by two adjacent pixels, the digital-analog converter circuit of one of the two pixels outputs voltages corresponding to any two colors of the RGB colors, and the digital-analog converter circuit of the other one of the two pixels outputs a voltage corresponding the other color of the RGB colors.

In an embodiment, each pixel is divided into above 2 regions with the same structures, and the above 2 regions are enabled or disenabled.

In an embodiment, the memory circuit has an SRAM or a DRAM.

The liquid crystal display device can be utilized in an electronic device providing users with images. The electronic device can be a television, a laptop computer, a desktop computer, a tablet computer, a cell phone, a digital camera, a PDA, a car navigation device, a portable game device, an AURORA VISION, or etc.

According to the invention, a liquid crystal display device capable of assuring high transmittance and/or reflectance and displaying multicolor stably, and an electronic device using the same are provided.

### BRIEF DESCRIPTION OF THE DRAWINGS

The present invention can be more fully understood by reading the subsequent detailed description and examples with references made to the accompanying drawings, wherein:

FIG. 1 is a block diagram of a display device in accordance with an embodiment of the invention.

FIG. 2 is a block diagram of a pixel structure in the display device in accordance with an embodiment of the invention.

FIG. 3 shows a circuit diagram of the pixel structure shown in FIG. 2.

FIG. 4 is a block diagram of a pixel structure in the display device in accordance with an embodiment of the invention.

FIG. 5 shows a circuit diagram of the pixel structure shown in FIG. 4.

FIG. 6 is a circuit diagram of a pixel structure in the display device in accordance with an embodiment of the invention.

FIG. 7 is a block diagram of a pixel structure in the display device in accordance with an embodiment of the invention.

FIG. 8 shows a circuit diagram of the pixel structure shown in FIG. 7.

FIG. 9 is a circuit diagram of a pixel structure in the display device in accordance with an embodiment of the invention.

FIG. 10 is a plane view of the pixel structure of the pixel circuit shown in FIG. 9.

FIG. 11 is a diagram showing the relations among the voltage applied to the pixel electrode, the cell gap, and the wavelength of the color displayed by the pixel.

FIG. 12 is a plane view of a pixel structure in the display device in accordance with an embodiment of the invention.

FIG. 13 is a diagram for illustrating the display control of the pixel shown in FIG. 12.

FIG. 14 is an example showing an electronic device provided with a display device in accordance with an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

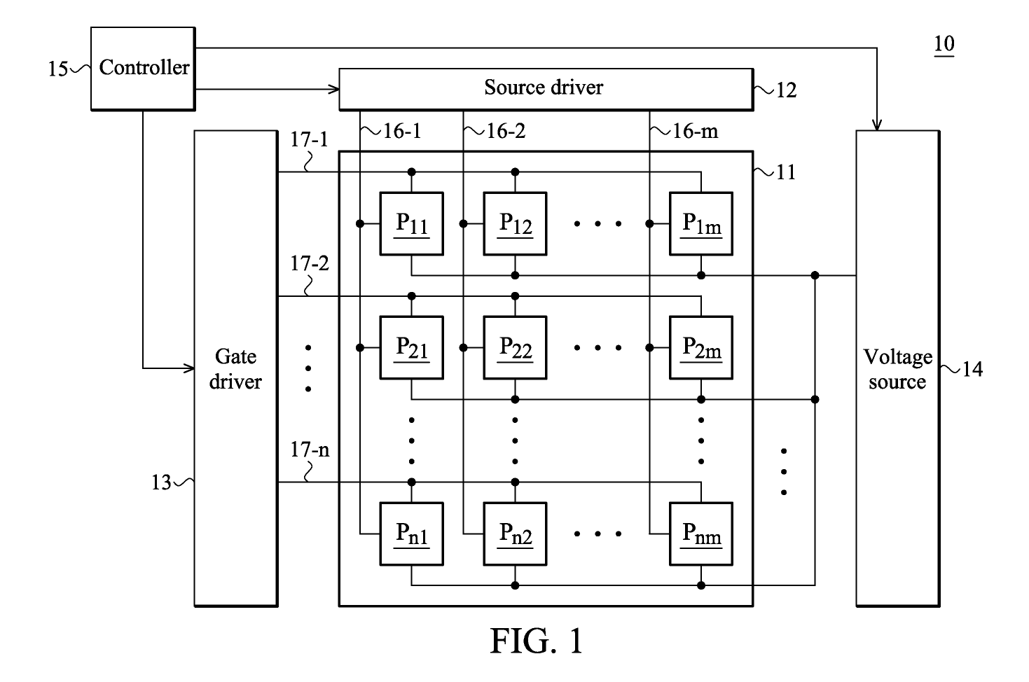

FIG. 1 is a block diagram of a display device in accordance with an embodiment of the invention. In FIG. 1, a display device 10 comprises a display panel 11, a source driver 12, a gate driver 13, a voltage source 14, and a controller 15.

The display panel 11 comprises a plurality of pixels P₁₁˜Pₙₘ (m and n are integers) arranged in a matrix formed by rows and columns. The display panel 11 further comprises a plurality of source lines 16-1, 16-2, . . . , and 16-m arranged corresponding to the columns, and a plurality of gate lines 17-1, 17-2, . . . , and 17-n arranged corresponding to the rows and orthogonal to the source lines 16-1, 16-2, . . . , and 16-m.

The source driver 12 is a signal driving circuit which drives the source lines 16-1˜16-m according to data signals. The source driver 12 applies signal voltages to the pixels P₁₁˜Pₙₘ via the source lines 16-1˜16-m. The gate driver 13 is a gate line driving circuit which drives the gate lines 17-1˜17-n in sequence. The gate driver 13 controls signal voltage applications for the pixels P₁₁˜Pₙₘ via the gate lines 17-1˜17-n. Specifically, the gate driver 13 drives pixel rows with an interlaced scan or progressive scan procedure so that the pixels on that pixel row are applied with signal voltages through the source lines.

The voltage source 14 provides the pixels P₁₁˜Pₙₘ with voltages corresponding to the display colors. In the liquid crystal display device of the invention, for a pixel, a part of the voltages supplied by the voltage source 14 are selected according to the signal voltage applied to the pixel, and thereby the orientation of the liquid crystal molecule is varied to acquire a desired display color.

The controller 15 synchronizes the source driver 12, the gate driver 13, and voltage source 14 together, and controls the above devices.

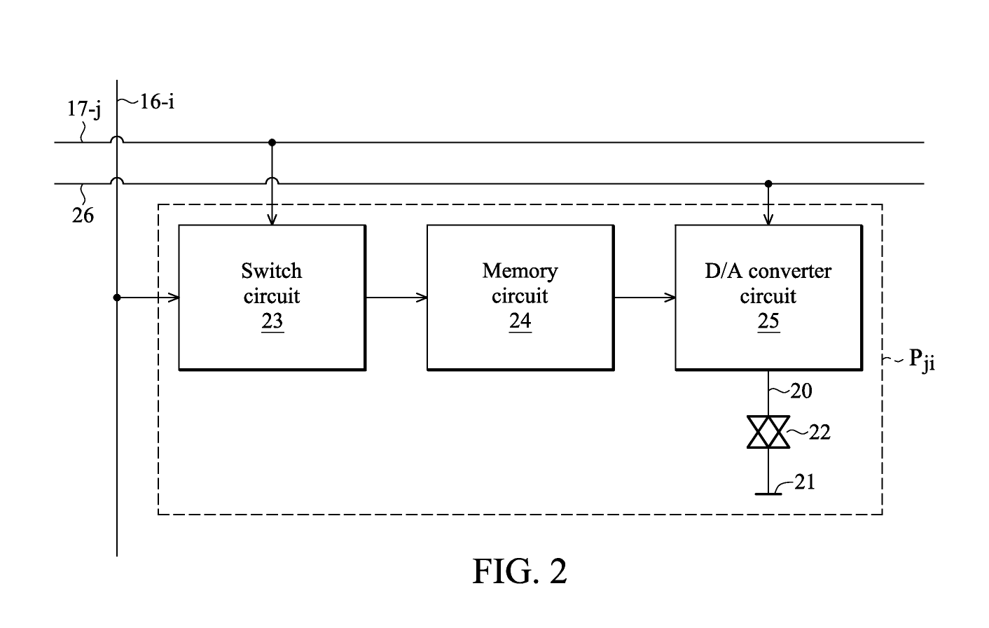

FIG. 2 is a block diagram of a pixel structure in the display device in accordance with an embodiment of the invention.

The pixel Pⱼᵢ (i and j are integers, wherein 1≦i≦m and 1≦j≦n) is arranged at the cross region of the i-th source line 16-i and the j-th gate line 17-j.

The pixel Pⱼᵢ has a pixel electrode 20 formed on a transparent substrate (not shown in FIG. 2) and an opposite electrode 21 formed on an opposite transparent substrate (not shown in FIG. 2). The opposite electrode 21 is connected to a fixed voltage source (not shown in FIG. 2). Because the opposite electrode 21 is shared by all pixels, it is called “a common electrode.” The liquid crystal is injected into the space between the two transparent substrates, forming a liquid crystal cell 22 between the pixel electrode 20 and the opposite electrode 21.

The pixel Pⱼᵢ further comprises a switch circuit 23, a memory circuit 24, and a digital-analog (D/A) converter circuit 25. The switch circuit 23 is connected to the source line 16-i and the gate line 17-j, and switches on in response to the scan signal from the gate line 17-j to connect the source line 16-i to the memory circuit 24. The memory circuit 24 can store a signal voltage from the source line 16-i by binary values (0 and 1). The D/A converter circuit 25 is connected to the voltage source 14 (FIG. 1) via a voltage supply line 26. The D/A converter circuit 25 uses the voltage supplied by the voltage source 14 via the voltage supply line 26 to convert the binary values stored in the memory circuit 24 into an analog voltage. The analog voltage converted by the D/A converter circuit 25 is applied to the pixel electrode 20. Thus, the orientation of the liquid crystal molecules of the liquid crystal cell 22 is varied to display a color corresponding to the analog voltage.

As shown in FIG. 2, a technique where a memory is installed in a pixel is called an MIP (Memory in Pixel) technique. In the MIP technique, a memory is installed in each pixel so that when a static image is displayed, the data stored in the memory is written to the pixel. In this regard, driving of the driver can be stopped to reduce power consumption. The MIP technique is especially suitable for a reflective type liquid crystal display. The reflective type liquid crystal display consumes lower power because no backlight is configured therein, and is usually utilized in a mobile phone which is driven by a battery. For example, the mobile phone is utilized, most of the times, under a stand-by mode. In this period, a large part of or the entire screen of the display device is used to display a static image generally. Therefore, the MIP technique can be applied to save power consumption.

In the MIP technique, a predetermined voltage corresponding to the data stored in the memory is applied to the pixel electrode, so that the voltage applied to the pixel voltage is almost not varied. Therefore, The MIP technique is especially suitable for the color liquid crystal display device using the characteristic of the birefringence of the liquid crystal molecule. This kind of color liquid crystal display device is sensitive to the variation of the voltage applied to the pixel electrode.

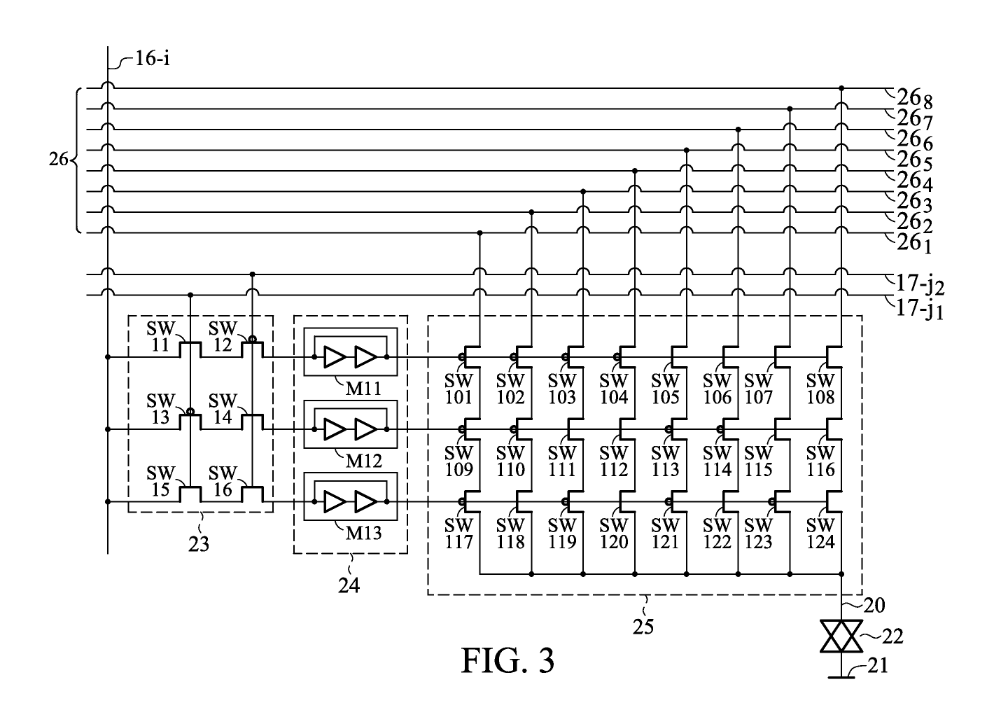

FIG. 3 shows a circuit diagram of the pixel structure shown in FIG. 2.

The switch circuit 23 has 6 switch elements SW11˜SW16. The switch elements SW11 and SW12 are connected in series and disposed between the source line 16-i and the memory circuit 24. The switch elements SW13 and SW14 are connected in series and disposed between the source line 16-i and the memory circuit 24. The switch elements SW15 and SW16 are connected in series and disposed between the source line 16-i and the memory circuit 24. The control terminals of the switch elements SW11, SW13, and SW15 are connected to a first gate line 17-j₁. The control terminals of the switch elements SW12, SW14, and SW16 are connected to a second gate line 17-j₂. The switch elements SW12 and SW13 have switch characteristics opposite to those of the other switch elements SW11, SW14, SW15, and SW16. Thus, the switch element SW12 is turned off when the switch elements SW14 and SW16 are turned on in response to the scan signal from the second gate line 17-j₂. Otherwise, the switch element SW12 is turned on when the switch elements SW14 and SW16 are turned off. Similarly, the switch element SW13 is turned off when the switch elements SW11 and SW15 are turned on in response to the scan signal from the first gate line 17-j₁. Otherwise, the switch element SW13 is turned on when the switch elements SW11 and SW15 are turned off.

The memory circuit 24 has three 1-bit memories M11˜M13. The first memory M11 is connected to the series connection circuit of the switch elements SW11 and SW12. When the switch elements SW11 and SW12 are turned on, the first memory M11 is connected to the source line 16-i. The second memory M12 is connected to the series connection circuit of the switch elements SW13 and SW14. When the switch elements SW13 and SW14 are turned on, the second memory M12 is connected to the source line 16-i. The third memory M13 is connected to the series connection circuit of the switch elements SW15 and SW16. When the switch elements SW15 and SW16 are turned on, the third memory M13 is connected to the source line 16-i.

The memories M11˜M13 can be, for example, an SRAM (Static Random Access Memory) or a DRAM (Dynamic Random Access Memory). Generally, SRAMs or DRAMs are usually adopted in the MIP technique to hold the data stored in the memory in each pixel. An SRAM is constituted by a logic circuit of transistors. On the other hand, a DRAM is constituted by a transistor and a capacitor. Thus, in view of minification of the circuit area and narrowing of the pixel gap, the DRAM is preferred. However, a DRAM needs a refresh operation to hold tiny electric charges stored in the capacitor.

The D/A converter circuit 25 has 24 switch elements SW101˜SW124. A first series connection circuit of the switch elements SW101, SW109, and SW117 is disposed between the pixel electrode 20 and a first voltage supply line 26₁. A second series connection circuit of the switch elements SW102, SW110, and SW118 is disposed between the pixel electrode 20 and a second voltage supply line 26₂. A third series connection circuit of the switch elements SW103, SW111, and SW119 is disposed between the pixel electrode 20 and a third voltage supply line 26₃. A fourth series connection circuit of the switch elements SW104, SW112, and SW120 is disposed between the pixel electrode 20 and a fourth voltage supply line 26₄. A fifth series connection circuit of the switch elements SW105, SW113, and SW121 is disposed between the pixel electrode 20 and a fifth voltage supply line 26₅. A sixth series connection circuit of the switch elements SW106, SW114, and SW122 is disposed between the pixel electrode 20 and a sixth voltage supply line 26₆. A seventh series connection circuit of the switch elements SW107, SW115, and SW123 is disposed between the pixel electrode 20 and a seventh voltage supply line 26₇. A eighth series connection circuit of the switch elements SW108, SW116, and SW124 is disposed between the pixel electrode 20 and an eighth voltage supply line 26₈.

The control terminals of the switch elements SW101˜SW108 are connected to the output end of the first memory M11. The switch elements SW101˜SW104 have switch characteristics opposite to those of the other switch elements SW105˜SW108. Thus, the switch elements SW101˜SW104 are turned off when the switch elements SW105˜SW108 are turned on in response to the output from the first memory M11. Otherwise, the switch elements SW101˜SW104 are turned on when the switch elements SW105˜SW108 are turned off.

The control terminals of the switch elements SW109˜SW116 are connected to the output end of the second memory M12. The switch elements SW109, SW110, SW113, and SW114 have switch characteristics opposite to those of the other switch elements SW111, SW112, SW115, and SW116. Thus, the switch elements SW109, SW110, SW113, and SW114 are turned off when the switch elements SW111, SW112, SW115, and SW116 are turned on in response to the output from the second memory M12. Otherwise, the switch elements SW109, SW110, SW113, and SW114 are turned on when the switch elements SW111, SW112, SW115, and SW116 are turned off.

The control terminals of the switch elements SW117˜SW124 are connected to the output end of the third memory M13. The switch elements SW117, SW119, SW121, and SW123 have switch characteristics opposite to those of the other switch elements SW118, SW120, SW122, and SW124. Thus, the switch elements SW117, SW119, SW121, and SW123 are turned off when the switch elements SW118, SW120, SW122, and SW124 are turned on in response to the output from the third memory M13. Otherwise, the switch elements SW117, SW119, SW121, and SW123 are turned on when the switch elements SW118, SW120, SW122, and SW124 are turned off.

The first to eighth voltage supply lines 26₁˜26₈ are applied by the voltage source 14 (FIG. 1) with different voltages corresponding to specific color components respectively. The first to eighth voltage supply lines 26₁˜26₈ are applied with voltages Vk, Vb, Vg, Vc, Vr, Vm, Vy, and Vw, respectively, corresponding to black, blue, green, cyan, red, magenta, yellow, and white colors.

The scan signal from the gate line 17-j is divided into a 3-bit data. For example, the scan signal is a waveform of voltage pulses wherein the duration thereof is T. During the first T/3 period, the voltage level of the first gate line 17-j₁ is driven at a high voltage level, and the voltage level of the second gate line 17-j₂ is driven at a low voltage level. Thus, the switch elements SW11 and SW12 in the switch circuit 23 are turned on, so that the first memory M11 in the memory circuit 24 is connected to the source line 16-i. During the second T/3 period, the voltage level of the first gate line 17-j₁ is driven at a low voltage level, and the voltage level of the second gate line 17-j₂ is driven at a high voltage level. Thus, the switch elements SW13 and SW14 in the switch circuit 23 are turned on, so that the second memory M12 in the memory circuit 24 is connected to the source line 16-i. During the last T/3 period, the voltage levels of the first gate line 17-j₁ and the second gate line 17-j₂ are both driven at a high voltage level. Thus, the switch elements SW15 and SW16 in the switch circuit 23 are turned on, so that the third memory M13 in the memory circuit 24 is connected to the source line 16-i. In this way, the first, second, and third memories M11˜M13 are connected to the source line 16-i in sequence. The source line 16-i is driven by the source driver 12 (FIG. 1) in the manner of synchronizing with the first gate line 17-j₁ and the second gate line 17-j₂.

For example, considering the case where the pixel Pⱼᵢ is controlled to display a red color, during the scan period T right before the j-th pixel row is selected, the voltage level of the source line 16-i is driven at a high voltage level only during the first T/3 period and the first to third memories M11˜M13 store 1, 0, and 0, respectively. As a result, from the end of the scan period T to the next scan period, the first to third memories M11˜M13 output binary values 1, 0, and 0, respectively. Therefore, the pixel electrode 20 is connected to the fifth voltage supply line 26₅ supplying the voltage Vr corresponding to the red color via the switch elements SW105, SW113, and SW121.

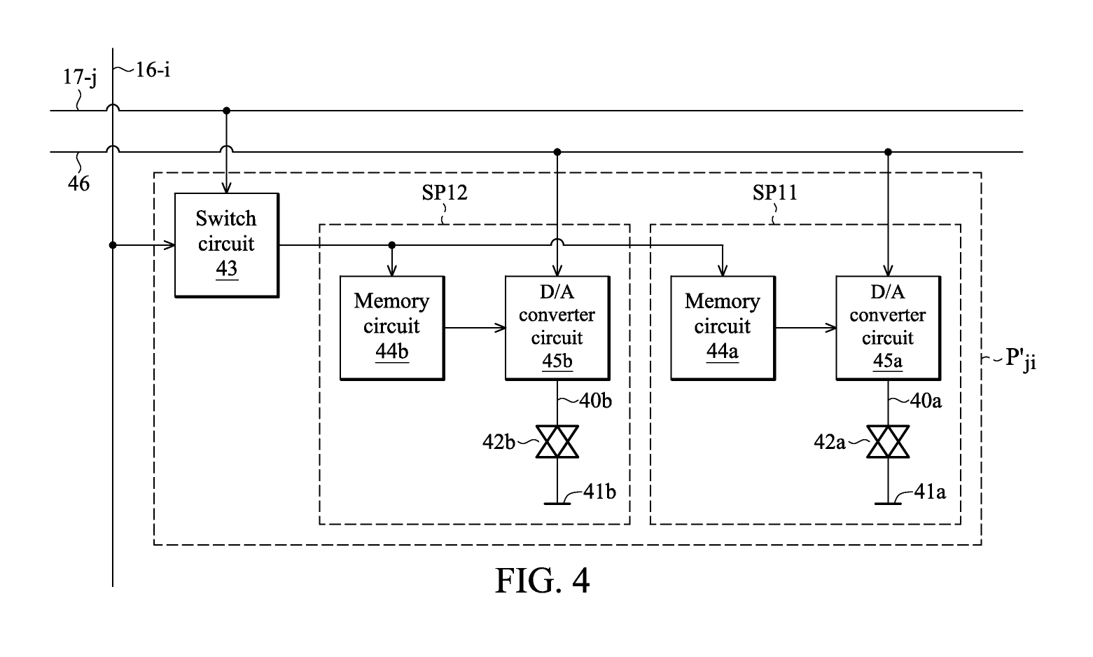

FIG. 4 is a block diagram of a pixel structure in the display device in accordance with an embodiment of the invention.

The pixel P′ⱼᵢ comprises 2 subpixels SP11 and SP12, and a switch circuit 43. The subpixels SP11 and SP12 have pixel electrodes 40a and 40b, opposite electrodes 41a and 41b, liquid crystal cells 42a and 42b located between the pixel electrodes and the opposite electrodes, memory circuits 44a and 44b, and D/A converter circuits 45a and 45b, respectively.

The switch circuit 43 is connected to the source line 16-i and the gate line 17-j, and switches on in response to the scan signal from the gate line 17-j to connect the source line 16-i to the memory circuits 44a and 44b. Each of the memory circuits 44a and 44b can store a signal voltage from the source line 16-i by binary values (0 and 1). The D/A converter circuits 45a and 45b are connected to the voltage source 14 (FIG. 1) via a voltage supply line 46. The D/A converter circuits 45a and 45b use the voltage supplied by the voltage source 14 via the voltage supply line 46 to convert the binary values stored in the memory circuits 44a and 44b into analog voltages. The analog voltages converted by the D/A converter circuits 45a and 45b are applied to the pixel electrode 40a and 40b.

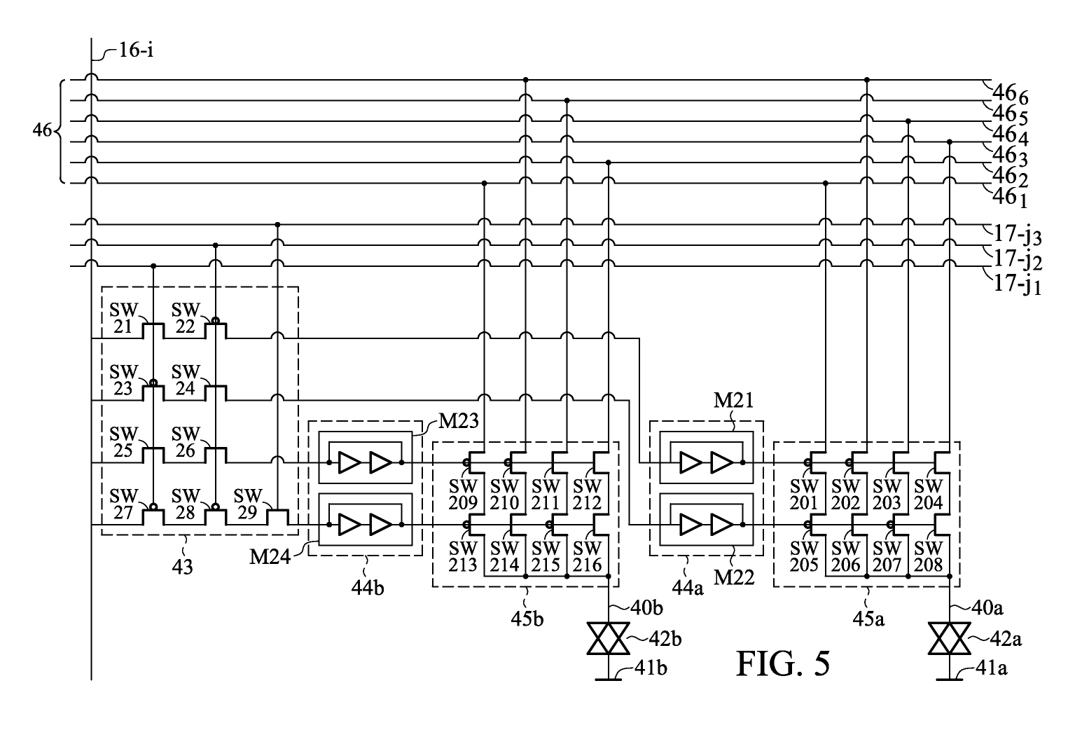

FIG. 5 shows a circuit diagram of the pixel structure shown in FIG. 4.

The switch circuit 43 has 9 switch elements SW21˜SW29. The switch elements SW21 and SW22 are connected in series and disposed between the source line 16-i and the first memory circuit 44a disposed in the first subpixel SP11 (FIG. 4). The switch elements SW23 and SW24 are connected in series and disposed between the source line 16-i and the first memory circuit 44a. The switch elements SW25 and SW26 are connected in series and disposed between the source line 16-i and the second memory circuit 44b disposed in the second subpixel SP12 (FIG. 4). The switch elements SW27, SW28 and SW29 are connected in series and disposed between the source line 16-i and the second memory circuit 44b. The control terminals of the switch elements SW21, SW23, SW25, and SW27 are connected to a first gate line 17-j₁. The control terminals of the switch elements SW22, SW24, SW26, and SW28 are connected to a second gate line 17-j₂. The control terminals of the switch element SW29 is connected to a third gate line 17-j₃.The switch elements SW22 and SW28 have switch characteristics opposite to those of the switch elements SW24, and SW26. Thus, the switch elements SW22 and SW28 are turned off when the switch elements SW24 and SW26 are turned on in response to the scan signal from the second gate line 17-j₂. Otherwise, the switch elements SW22 and SW28 are turned on when the switch elements SW24 and SW26 are turned off. Similarly, the switch elements SW23 and SW27 have switch characteristics opposite to those of the switch elements SW21, and SW25. Thus, the switch elements SW23 and SW27 are turned off when the switch elements SW21 and SW25 are turned on in response to the scan signal from the first gate line 17-j₁. Otherwise, the switch elements SW23 and SW27 are turned on when the switch elements SW21 and SW25 are turned off.

The first memory circuit 44a has two 1-bit memories M21 and M22. The first memory M21 is connected to the series connection circuit of the switch elements SW21 and SW22. When the switch elements SW21 and SW22 are turned on, the first memory M21 is connected to the source line 16-i. The second memory M22 is connected to the series connection circuit of the switch elements SW23 and SW24. When the switch elements SW23 and SW24 are turned on, the second memory M22 is connected to the source line 16-i.

The first D/A converter circuit 45a disposed in the first subpixel SP11 (FIG. 4) has 8 switch elements SW201˜SW208. A first series connection circuit of the switch elements SW201 and SW205 is disposed between the pixel electrode 40a and a first voltage supply line 46₁. A second series connection circuit of the switch elements SW202 and SW206 is disposed between the pixel electrode 40a and a sixth voltage supply line 46₆. A third series connection circuit of the switch elements SW203 and SW207 is disposed between the pixel electrode 40a and a fourth voltage supply line 46₄. A fourth series connection circuit of the switch elements SW204 and SW208 is disposed between the pixel electrode 40a and a third voltage supply line 46₃.

The control terminals of the switch elements SW201˜SW204 are connected to the output end of the first memory M21. The switch elements SW201 and SW202 have switch characteristics opposite to those of the switch elements SW203 and SW204. Thus, the switch elements SW201 and SW202 are turned off when the switch elements SW203˜SW204 are turned on in response to the output from the first memory M21. Otherwise, the switch elements SW201 and SW202 are turned on when the switch elements SW203 and SW204 are turned off.

The control terminals of the switch elements SW205˜SW208 are connected to the output end of the second memory M22. The switch elements SW205 and SW207 have switch characteristics opposite to those of the switch elements SW206 and SW208. Thus, the switch elements SW205 and SW207 are turned off when the switch elements SW206 and SW208 are turned on in response to the output from the second memory M22. Otherwise, the switch elements SW205 and SW207 are turned on when the switch elements SW206 and SW208 are turned off.

The second memory circuit 44b has two 1-bit memories M23 and M24. The third memory M23 is connected to the series connection circuit of the switch elements SW25 and SW26. When the switch elements SW25 and SW26 are turned on, the third memory M23 is connected to the source line 16-i. The fourth memory M24 is connected to the series connection circuit of the switch elements SW27˜SW29. When the switch elements SW27˜SW29 are turned on, the fourth memory M24 is connected to the source line 16-i.

The second D/A converter circuit 45b disposed in the first subpixel SP12 (FIG. 4) has 8 switch elements SW209˜SW216. A first series connection circuit of the switch elements SW209, and SW213 is disposed between the pixel electrode 40b and the first voltage supply line 46₁. A second series connection circuit of the switch elements SW210 and SW214 is disposed between the pixel electrode 40b and the sixth voltage supply line 46₆. A third series connection circuit of the switch elements SW211, and SW215 is disposed between the pixel electrode 40b and a fifth voltage supply line 46₅. A fourth series connection circuit of the switch elements SW212, and SW216 is disposed between the pixel electrode 40b and a second voltage supply line 46₂.

The control terminals of the switch elements SW209˜SW212 are connected to the output end of the third memory M23. The switch elements SW209 and SW210 have switch characteristics opposite to those of the switch elements SW211 and SW212. Thus, the switch elements SW209 and SW210 are turned off when the switch elements SW211 and SW212 are turned on in response to the output from the third memory M23. Otherwise, the switch elements SW209 and SW210 are turned on when the switch elements SW211 and SW212 are turned off.

The control terminals of the switch elements SW213˜SW216 are connected to the output end of the fourth memory M24. The switch elements SW213 and SW215 have switch characteristics opposite to those of the switch elements SW214 and SW216. Thus, the switch elements SW213 and SW215 are turned off when the switch elements SW214 and SW216 are turned on in response to the output from the fourth memory M24. Otherwise, the switch elements SW213 and SW215 are turned on when the switch elements SW214 and SW216 are turned off.

The first to sixth voltage supply line 46₁˜46₆ are applied by the voltage source 14 (FIG. 1) with different voltages corresponding to specific color components respectively. The first to sixth voltage supply line 46₁˜46₆ are applied with voltages Vk, Vb, Vg, Vr, Vy, and Vw, respectively, corresponding to black, blue, green, red, yellow, and white colors.

The scan signal from the gate line 17-j is divided into a 4-bit data. For example, the scan signal is a waveform of voltage pulses wherein the duration thereof is T. During the first T/4 period, the voltage level of the first gate line 17-j₁ is driven at a high voltage level, and the voltage levels of the second and third gate lines 17-j₂ and 17-j₃ are driven at a low voltage level. Thus, the switch elements SW21 and SW22 in the switch circuit 43 are turned on, so that the first memory M21 in the first memory circuit 44a is connected to the source line 16-i. During the second T/4 period, the voltage level of the second gate line 17-j₂ is driven at a high voltage level, and the voltage levels of the first and third gate lines 17-j₁ and 17-j₃ are driven at a low voltage level. Thus, the switch elements SW23 and SW24 in the switch circuit 43 are turned on, so that the second memory M22 in the first memory circuit 44a is connected to the source line 16-i. During the third T/4 period, the voltage levels of the first and second gate lines 17-j₁ and 17-j₂ are driven at a high voltage level, and the voltage level of the third gate line 17-j₃ is driven at a low voltage level. Thus, the switch elements SW25 and SW26 in the switch circuit 43 are turned on, so that the third memory M23 in the second memory circuit 44b is connected to the source line 16-i. During the last T/4 period, the voltage level of the third gate line 17-j₃ is driven at a high voltage level, and the voltage levels of the first and second gate lines 17-j₁ and 17-j₂ are driven at a low voltage level. Thus, the switch elements SW27˜SW29 in the switch circuit 43 are turned on, so that the third memory M24 in the second memory circuit 44b is connected to the source line 16-i. In this way, the first, second, third, and fourth memories M21˜M24 are connected to the source line 16-i in sequence. The source line 16-i is driven by the source driver 12 (FIG. 1) in the manner of synchronizing with the first gate line 17-j₁, the second gate line 17-j₂, and the third gate line 17-j₃.

For example, considering the case where the pixel P′ⱼᵢ is controlled to display a magenta color, during the scan period T right before the j-th pixel row is selected, the voltage level of the source line 16-i is driven at a high voltage level except during the second T/4 period (T/4˜2T/4) and the first to fourth memories M21˜M24 store 1, 0, 1, and 1, respectively. As a result, from the end of the scan period T to the next scan period, the first to fourth memories M21˜M24 output binary values 1, 0, 1, and 1, respectively. Therefore, the pixel electrode 40a is connected to the fourth voltage supply line 46₄ supplying the voltage Vr corresponding to the red color via the switch elements SW203, and SW207. The pixel electrode 40b is connected to the second voltage supply line 46₂ supplying the voltage Vb corresponding to the blue color via the switch elements SW212, and SW216. As a result, the pixel P′ⱼᵢ displays magenta which is mixed by red and blue.

In the pixel circuit shown in FIG. 5, a pixel is divided into subpixels so that a color can be displayed by mixing two colors of the subpixels. In this regard, there is no need to dispose voltage supply lines for every color component. In comparison with the pixel circuit shown in FIG. 3, the pixel circuit shown in FIG. 5 can improve the aperture and provide a display with higher resolution.

In the example of FIG. 5, the first subpixel SP11 of the pixel P′ⱼᵢ can display red (R), green (G), white (W), and black (K), and the second subpixel SP12 of the pixel P′ⱼᵢ can display blue (B), yellow (Y), white (W), and black (K). In addition to black, white, and RGB colors, the other necessary color depends on the color combination which can be provided by a subpixel. In the example of FIG. 5, red and green cannot be displayed at the same time, so yellow which is a color mixed by red and green is needed additionally.

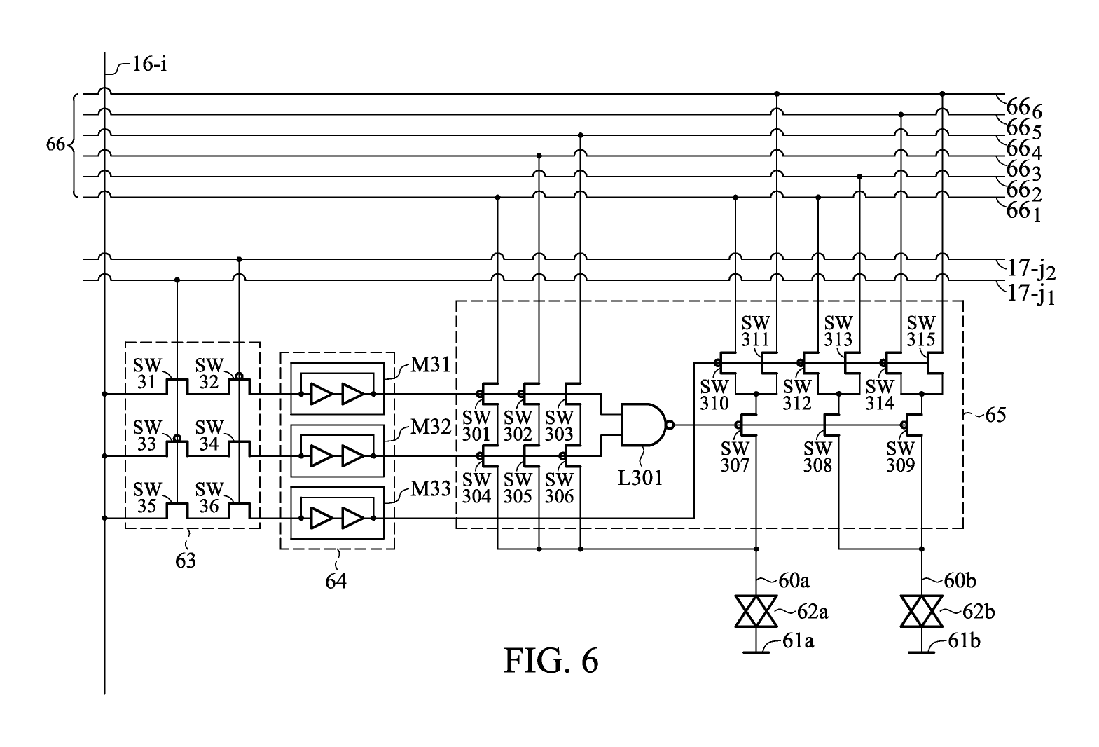

FIG. 6 is a circuit diagram of a pixel structure in the display device in accordance with an embodiment of the invention.

The pixel shown in FIG. 6 is divided into 2 subpixels comprising pixel electrodes 60a and 60b, and opposite electrodes 61a and 61b, respectively. The pixel further comprises a switch circuit 63, a memory circuit 64, and a D/A circuit 65. The switch circuit 63 is connected to the source line 16-i, the first gate line 17-j₁, and the second gate line 17-j₂, and switches on in response to the scan signal from the first gate line 17-j₁ and the second gate line 17-j₂ to connect the source line 16-i to the memory circuit 64. The memory circuit 64 can store a signal voltage from the source line 16-i by binary values (0 and 1). The D/A converter circuit 65 is connected to the voltage source 14 (FIG. 1) via a voltage supply line 66. The D/A converter circuit 65 uses the voltage supplied by the voltage source 14 via the voltage supply line 66 to convert the binary values stored in the memory circuit 64 into analog voltages. The analog voltages converted by the D/A converter circuit 65 are applied to the pixel electrode 60a and 60b. Thus, the orientations of the liquid crystal molecules of the liquid crystal cells 62a and 62b are varied to display the colors corresponding to the analog voltages.

The structures and the operations of the switch circuit 63 and the memory circuit 64 are the same as those of the pixel circuit shown in FIG. 3. Thus, the details are not described again.

The D/A converter circuit 65 has 15 switch elements SW301˜SW315 and a NAND circuit. A first series connection circuit of the switch elements SW301 and SW304 is disposed between the first pixel electrode 60a and a first voltage supply line 66₁. A second series connection circuit of the switch elements SW302 and SW305 is disposed between the first pixel electrode 60a and a third voltage supply line 66₃. A third series connection circuit of the switch elements SW303 and SW306 is disposed between the first pixel electrode 60a and a fourth voltage supply line 66₄.

The control terminals of the switch elements SW301˜SW303 are connected to the output end of the first memory M31. The switch elements SW301 and SW302 have switch characteristics opposite to that of the switch element SW303. Thus, the switch elements SW301 and SW302 are turned off when the switch element SW303 is turned on in response to the output from the first memory M31. Otherwise, the switch elements SW301 and SW302 are turned on when the switch element SW303 is turned off.

The control terminals of the switch elements SW304˜SW306 are connected to the output end of the second memory M32. The switch elements SW304 and SW306 have switch characteristics opposite to that of the switch element SW305. Thus, the switch elements SW304 and SW306 are turned off when the switch element SW305 is turned on in response to the output from the second memory M32. Otherwise, the switch elements SW304 and SW306 are turned on when the switch element SW305 is turned off.

The outputs of the first and second memory M31 and M32 are further connected to two input terminals of the NAND circuit L301, respectively.

The switch element SW307 is disposed between the first pixel electrode 60a and the parallel connection circuit of the switch elements SW310 and SW311. The control terminals of the switch elements SW310 and SW311 are connected to the output end of the third memory M33. The switch elements SW310 and SW311 have opposite switch characteristics. The switch element SW310 connects the conducted path of the switch element SW307 to the first voltage supply line 66₁. The switch element SW311 connects the conducted path of the switch element SW307 to the sixth voltage supply line 66₆.

The switch element SW308 is disposed between the second pixel electrode 60b and the parallel connection circuit of the switch elements SW312 and SW313. The control terminals of the switch elements SW312 and SW313 are connected to the output end of the third memory M33. The switch elements SW312 and SW313 have opposite switch characteristics. The switch element SW312 connects the conducted path of the switch element SW308 to the first voltage supply line 66₁. The switch element SW313 connects the conducted path of the switch element SW308 to a second voltage supply line 66₂.

The switch element SW309 is disposed between the second pixel electrode 60b and the parallel connection circuit of the switch elements SW314 and SW315. The control terminals of the switch elements SW314 and SW315 are connected to the output end of the third memory M33. The switch elements SW314 and SW315 have opposite switch characteristics. The switch element SW314 connects the conducted path of the switch element SW309 to a five voltage supply line 66₅. The switch element SW315 connects the conducted path of the switch element SW309 to the sixth voltage supply line 66₆.

The control terminals of the switch elements SW307˜SW309 are connected to the output end of the NAND circuit L301. The switch elements SW307 and SW309 have switch characteristics opposite to that of the switch element SW308. Thus, the switch elements SW307 and SW309 are turned off when the switch element SW308 is turned on. Otherwise, the switch elements SW307 and SW309 are turned on when the switch element SW308 is turned off.

The first to sixth voltage supply line 66₁˜66₆ are applied by the voltage source 14 (FIG. 1) with different voltages corresponding to specific color components respectively. The first to sixth voltage supply line 66₁˜66₆ are applied with voltages Vk, Vb, Vg, Vr, Vy, and Vw, respectively, corresponding to black, blue, green, red, yellow, and white colors.

For example, the case where the pixel shown in FIG. 6 is controlled to display a magenta color, during the scan period T right before the j-th pixel row is selected, the voltage level of the source line 16-i is driven at a high voltage level except during the second T/3 period (T/3˜2T/3) and the first to third memories M31˜M33 store 1, 0, and 1, respectively. As a result, from the end of the scan period T to the next scan period, the first to third memories M31˜M33 output binary values 1, 0, and 1, respectively. Therefore, the pixel electrode 60a is connected to the fourth voltage supply line 66₄ supplying the voltage Vr corresponding to the red color via the switch elements SW303, and SW306. The pixel electrode 60b is connected to the second voltage supply line 66₂ supplying the voltage Vb corresponding to the blue color via the switch elements SW313, and SW308. As a result, the pixel displays magenta which is mixed by red and blue.

In the pixel circuit shown in FIG. 6, the switch circuit, the memory circuit, and the D/A converter circuit are shared for subpixels. Thus, in comparison with the pixel circuit shown in FIG. 5, the pixel circuit shown in FIG. 6 can be constructed by less elements and gate lines, so that aperture can be further improved to be displayed with a higher resolution.

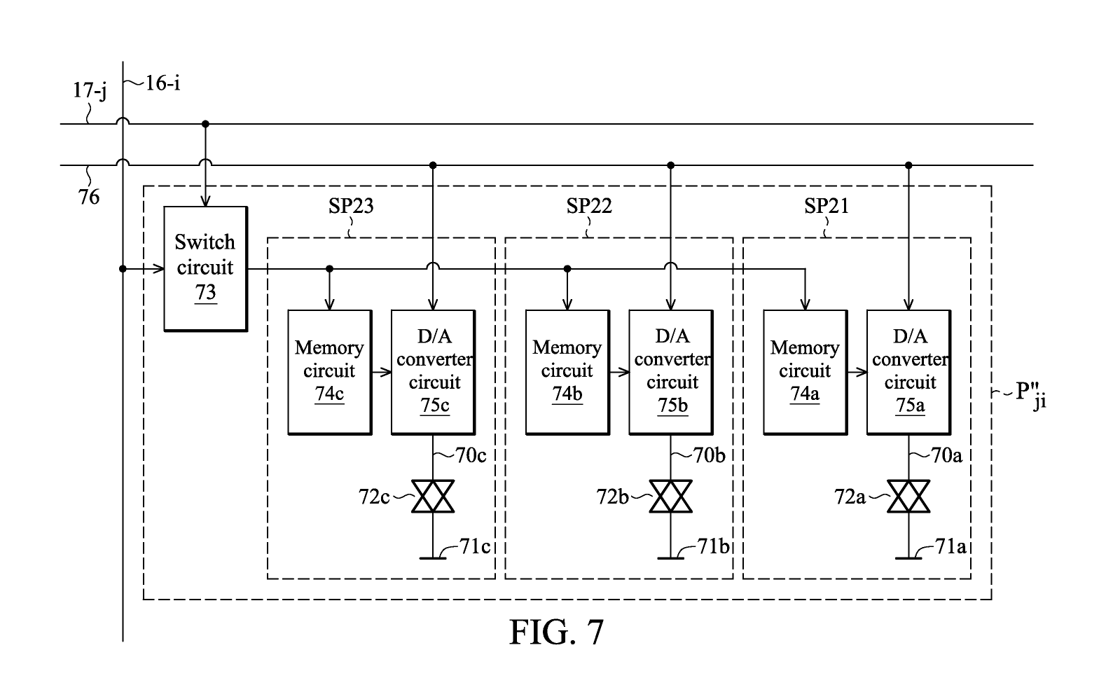

FIG. 7 is a block diagram of a pixel structure in the display device in accordance with an embodiment of the invention.

The pixel P″ⱼᵢ comprises 3 subpixels SP21˜SP23, and a switch circuit 73. The subpixels SP21˜SP23 have pixel electrodes 70a, 70b, and 70c, opposite electrodes 71a, 71b, and 71c, liquid crystal cells 72a, 72b, 72c located between the pixel electrodes and the opposite electrodes, memory circuits 74a, 74b, and 74c, and D/A converter circuits 75a, 75b, and 75c, respectively.

The switch circuit 73 is connected to the source line 16-i and the gate line 17-j, and switches on in response to the scan signal from the gate line 17-j to connect the source line 16-i to the memory circuits 74a, 74b, and 74c. Each of the memory circuits 74a, 74b, and 74c can store a signal voltage from the source line 16-i by binary values (0 and 1). The D/A converter circuits 75a, 75b, and 75c are connected to the voltage source 14 (FIG. 1) via a voltage supply line 76. The D/A converter circuits 75a, 75b, and 75c use the voltage supplied by the voltage source 14 via the voltage supply line 76 to convert the binary values stored in the memory circuits 74a, 74b, and 74c into analog voltages. The analog voltages converted by the D/A converter circuits 75a, 75b, and 75c are applied to the pixel electrode 70a, 70b, and 70c.

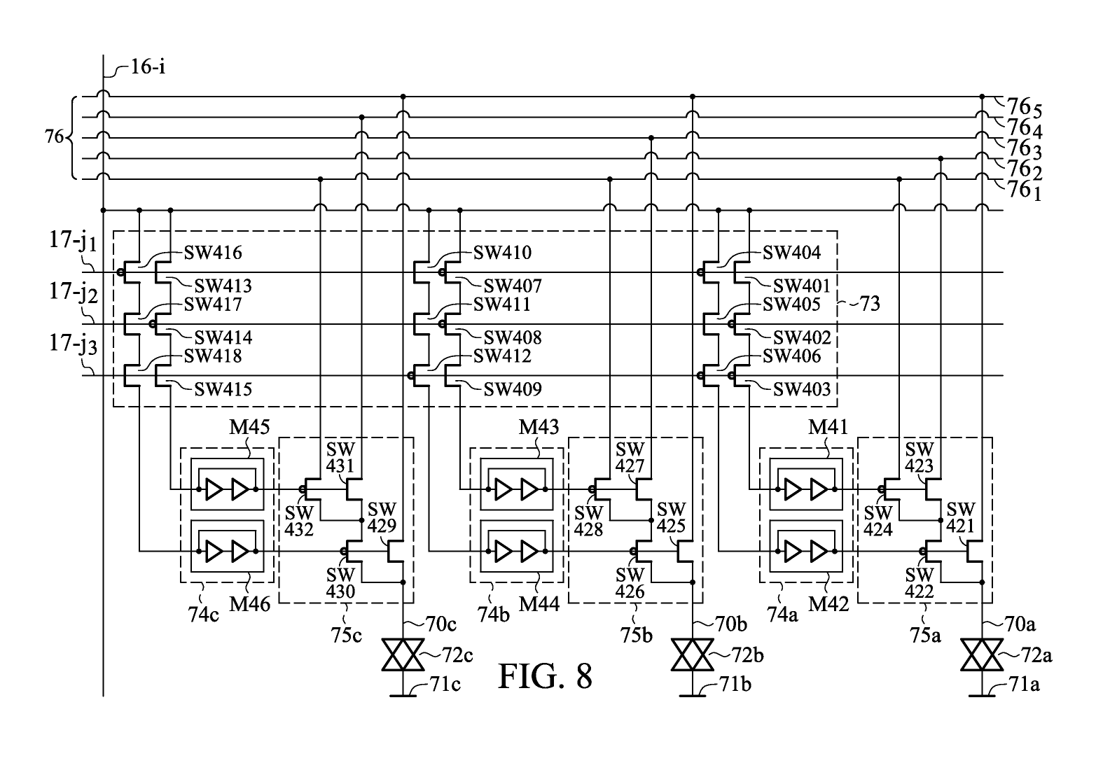

FIG. 8 shows a circuit diagram of the pixel structure shown in FIG. 7.

The switch circuit 73 has 18 switch elements SW401˜SW418. A first series connection circuit of the switch elements SW401˜SW403 and a second series connection circuit of the switch elements SW404˜SW406 are disposed between the source line 16-i and the first memory circuit 74a disposed in the first subpixel SP21 (FIG. 7). A third series connection circuit of the switch elements SW407˜SW409 and a fourth series connection circuit of the switch elements SW410˜SW412 are disposed between the source line 16-i and the second memory circuit 74b disposed in the second subpixel SP22 (FIG. 7). A fifth series connection circuit of the switch elements SW413˜SW415 and a sixth series connection circuit of the switch elements SW416˜SW418 are disposed between the source line 16-i and the third memory circuit 74c disposed in the third subpixel SP23 (FIG. 7).

The control terminals of the switch elements SW401, SW404, SW407, SW410, SW413, and SW416 are connected to a first gate line 17-j₁. The switch elements SW404, SW407, and SW416 have switch characteristics opposite to those of the switch elements SW401, SW410, and SW413. Thus, the switch elements SW404, SW407, and SW416 are turned off when the switch elements SW401, SW410, and SW413 are turned on in response to the scan signal from the first gate line 17-j₁. Otherwise, the switch elements SW404, SW407, and SW416 are turned on when the switch elements SW401, SW410, and SW413 are turned off.

The control terminals of the switch elements SW402, SW405, SW408, SW411, SW414, and SW417 are connected to a second gate line 17-j₂. The switch elements SW402, SW408, and SW414 have switch characteristics opposite to those of the switch elements SW405, SW411, and SW417. Thus, the switch elements SW402, SW408, and SW414 are turned off when the switch elements SW405, SW411, and SW417 are turned on in response to the scan signal from the second gate line 17-j₂. Otherwise, the switch elements SW402, SW408, and SW414 are turned on when the switch elements SW405, SW411, and SW417 are turned off.

The control terminals of the switch elements SW403, SW406, SW409, SW412, SW415, and SW418 are connected to a third gate line 17-j₃. The switch elements SW403, SW406, and SW412 have switch characteristics opposite to those of the switch elements SW409, SW415, and SW418. Thus, the switch elements SW403, SW406, and SW412 are turned off when the switch elements SW409, SW415, and SW418 are turned on in response to the scan signal from the third gate line 17-j₃. Otherwise, the switch elements SW403, SW406, and SW412 are turned on when the switch elements SW409, SW415, and SW418 are turned off.

The first memory circuit 74a has two 1-bit memories M41 and M42. The first memory M41 is connected to the first series connection circuit of the switch elements SW401˜SW403. When the switch elements SW401˜SW403 are turned on, the first memory M41 is connected to the source line 16-i. The second memory M42 is connected to the second series connection circuit of the switch elements SW404˜SW406. When the switch elements SW404˜SW406 are turned on, the second memory M42 is connected to the source line 16-i.

The first D/A converter circuit 75a disposed in the first subpixel SP21 (FIG. 7) has 4 switch elements SW421˜SW424. The switch element SW421 is disposed between the pixel electrode 70a and a fifth voltage supply line 76₅. The switch element SW422 is disposed between the pixel electrode 70a and a parallel connection circuit of the switch elements SW423 and SW424. The control terminals of the switch elements SW423 and SW424 are connected to the output end of the first memory M41. The switch elements SW423 and SW424 have opposite switch characteristics. Thus, the switch element SW423 connects the conducted path of the switch element SW422 to a second voltage supply line 76₂ in response to the output from the first memory M41. The switch element SW424 connects the conducted path of the switch element SW422 to a first voltage supply line 76₁ in response to the output from the first memory M41. The control terminals of the switch elements SW421 and SW422 are connected to the output end of the second memory M42. The switch elements SW421 and SW422 have opposite switch characteristics.

The second memory circuit 74b has two 1-bit memories M43 and M44. The third memory M43 is connected to the third series connection circuit of the switch elements SW407˜SW409. When the switch elements SW407˜SW409 are turned on, the third memory M43 is connected to the source line 16-i. The fourth memory M44 is connected to the fourth series connection circuit of the switch elements SW410˜SW412. When the switch elements SW410˜SW412 are turned on, the fourth memory M44 is connected to the source line 16-i.

The second D/A converter circuit 75b disposed in the second subpixel SP22 (FIG. 7) has 4 switch elements SW425˜SW428. The switch element SW425 is disposed between the pixel electrode 70b and the fifth voltage supply line 76₅. The switch element SW426 is disposed between the pixel electrode 70b and a parallel connection circuit of the switch elements SW427 and SW428. The control terminals of the switch elements SW427 and SW428 are connected to the output end of the third memory M43. The switch elements SW427 and SW428 have opposite switch characteristics. Thus, the switch element SW427 connects the conducted path of the switch element SW426 to a third voltage supply line 76₃ in response to the output from the third memory M43. The switch element SW428 connects the conducted path of the switch element SW426 to the first voltage supply line 76₁ in response to the output from the third memory M43. The control terminals of the switch elements SW425 and SW426 are connected to the output end of the fourth memory M44. The switch elements SW425 and SW426 have opposite switch characteristics.

The third memory circuit 74c has two 1-bit memories M45 and M46. The fifth memory M45 is connected to the fifth series connection circuit of the switch elements SW413˜SW415. When the switch elements SW413˜SW415 are turned on, the fifth memory M45 is connected to the source line 16-i. The sixth memory M46 is connected to the sixth series connection circuit of the switch elements SW416˜SW418. When the switch elements SW416˜SW418 are turned on, the sixth memory M46 is connected to the source line 16-i.

The third D/A converter circuit 75c disposed in the third subpixel SP23 (FIG. 7) has 4 switch elements SW429˜SW432. The switch element SW429 is disposed between the pixel electrode 70c and the fifth voltage supply line 76₅. The switch element SW430 is disposed between the pixel electrode 70c and a parallel connection circuit of the switch elements SW431 and SW432. The control terminals of the switch elements SW431 and SW432 are connected to the output end of the fifth memory M45. The switch elements SW431 and SW432 have opposite switch characteristics. Thus, the switch element SW431 connects the conducted path of the switch element SW430 to a fourth voltage supply line 76₄ in response to the output from the fifth memory M45. The switch element SW432 connects the conducted path of the switch element SW430 to the first voltage supply line 76₁ in response to the output from the fifth memory M45. The control terminals of the switch elements SW429 and SW430 are connected to the output end of the sixth memory M46. The switch elements SW429 and SW430 have opposite switch characteristics.

The first to fifth voltage supply line 76₁˜76₅ are applied by the voltage source 14 (FIG. 1) with different voltages corresponding to specific color components respectively. The first to fifth voltage supply line 76₁˜76₅ are applied with voltages Vk, Vb, Vg, Vr, and Vw, respectively, corresponding to black, blue, green, red, and white colors.

The scan signal from the gate line 17-j is divided into a 6-bit data. For example, the scan signal is a waveform of voltage pulses wherein the duration thereof is T. During the first T/6 period, the voltage level of the first gate line 17-j₁ is driven at a high voltage level, and the voltage levels of the second and third gate lines 17-j₂ and 17-j₃ are driven at a low voltage level. Thus, the switch elements SW401˜SW403 in the switch circuit 73 are turned on, so that the first memory M41 in the first memory circuit 74a is connected to the source line 16-i. During the second T/6 period, the voltage level of the second gate line 17-j₂ is driven at a high voltage level, and the voltage levels of the first and third gate lines 17-j₁ and 17-j₃ are driven at a low voltage level. Thus, the switch elements SW404˜SW406 in the switch circuit 73 are turned on, so that the second memory M42 in the first memory circuit 74a is connected to the source line 16-i. During the third T/6 period, the voltage level of the third gate line 17-j₃ is driven at a high voltage level, and the voltage levels of the first and second gate lines 17-j₁ and 17-j₂ are driven at a low voltage level. Thus, the switch elements SW407˜SW409 in the switch circuit 73 are turned on, so that the third memory M43 in the second memory circuit 74b is connected to the source line 16-i. During the fourth T/6 period, the voltage levels of the first and second gate lines 17-j₁ and 17-j₂ are driven at a high voltage level, and the voltage level of the third gate line 17-j₃ is driven at a low voltage level. Thus, the switch elements SW410˜SW412 in the switch circuit 73 are turned on, so that the fourth memory M44 in the second memory circuit 74b is connected to the source line 16-i. During the fifth T/6 period, the voltage levels of the first and third gate lines 17-j₁ and 17-j₃ are driven at a high voltage level, and the voltage level of the second gate line 17-j₂ is driven at a low voltage level. Thus, the switch elements SW413˜SW415 in the switch circuit 73 are turned on, so that the fifth memory M45 in the third memory circuit 74c is connected to the source line 16-i. During the last T/6 period, the voltage levels of the second and third gate lines 17-j₂ and 17-j₃ are driven at a high voltage level, and the voltage level of the first gate line 17-j₁ is driven at a low voltage level. Thus, the switch elements SW416˜SW418 in the switch circuit 73 are turned on, so that the sixth memory M46 in the third memory circuit 74c is connected to the source line 16-i. In this way, the first to sixth memories M41˜M46 are connected to the source line 16-i in sequence. The source line 16-i is driven by the source driver 12 (FIG. 1) in the manner of synchronizing with the first gate line 17-j₁, the second gate line 17-j₂, and the third gate line 17-j₃.

For example, considering the case where the pixel P′ⱼᵢ is controlled to display a magenta color, during the scan period T right before the j-th pixel row is selected, the voltage level of the source line 16-i is driven at a low voltage level except during the first T/6 period (0˜T/6) and the fifth T/6 period (4T/6˜5T/6), and the first to sixth memories M41˜M46 store 1, 0, 0, 0 1, and 0, respectively. As a result, from the end of the scan period T to the next scan period, the first to sixth memories M41˜M46 output binary values 1, 0, 0, 0, 1, and 0, respectively. Therefore, the pixel electrode 70a is connected to the second voltage supply line 76₂ supplying the voltage Vb corresponding to the blue color via the switch elements SW423, and SW422. The pixel electrode 70b is connected to the first voltage supply line 76₁ supplying the voltage Vk corresponding to the black color via the switch elements SW428, and SW426. The pixel electrode 70c is connected to the fourth voltage supply line 76₄ supplying the voltage Vr corresponding to the red color via the switch elements SW431, and SW430. As a result, the pixel P′ⱼᵢ displays magenta which is mixed by red and blue.

In the pixel circuit shown in FIG. 8, red (R), green (G), and blue (B) can be displayed by 3 subpixels. Therefore, only five voltage supply lines corresponding to five colors including RGB colors, a black color, and a white color are necessary.

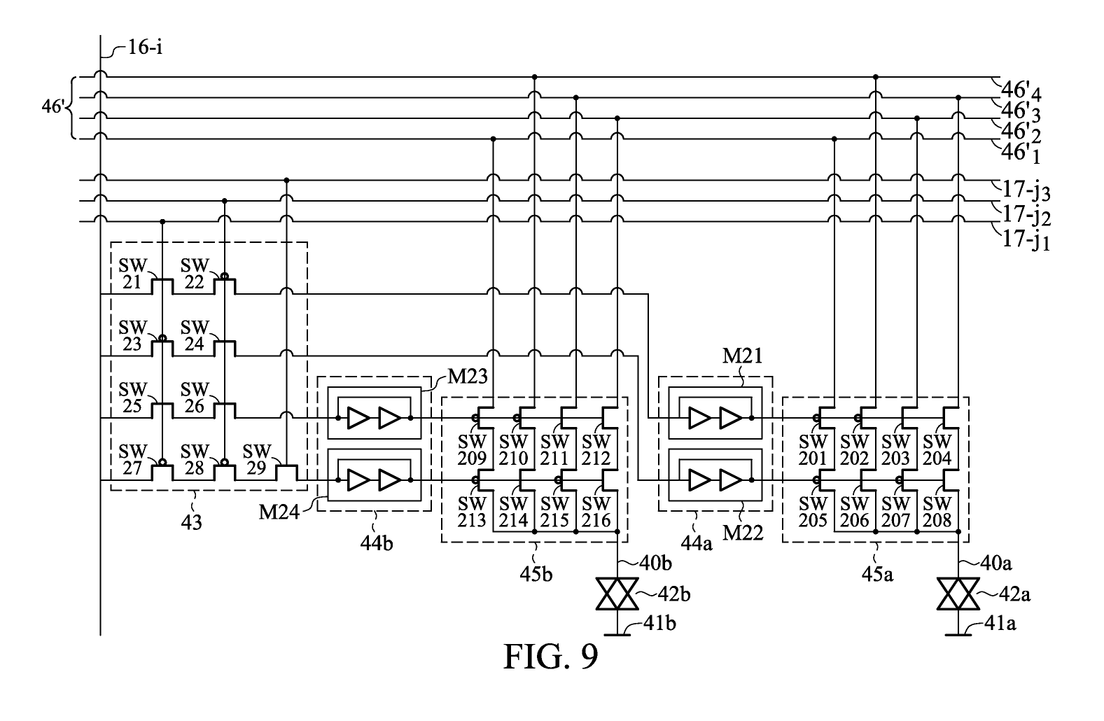

FIG. 9 is a circuit diagram of a pixel structure in the display device in accordance with an embodiment of the invention.

Except for the number of the voltage supply lines 46′, the pixel circuit shown in FIG. 9 is the same as the pixel circuit shown in FIG. 5. The voltage supply lines 46′ include first to fourth voltage lines 46′₁˜46′₄. The first to fourth voltage lines 46′ y-46′₄ are applied with different voltages corresponding to specific color components. For example, the first voltage supply line 46′₁ is applied with a voltage Vk corresponding to a black color, the second voltage supply line 46′₂ is applied with a voltage Vr/y corresponding to red and yellow colors, the third voltage supply line 46′₃ is applied with a voltage Vg/b corresponding to green and blue colors, and the fourth voltage supply line 46′₄ is applied with a voltage Vw corresponding to a white color. In this way, in the example of the Fig.9, a voltage supply line is disposed for two color components, which is different from that a voltage supply line is disposed for one color component described before.

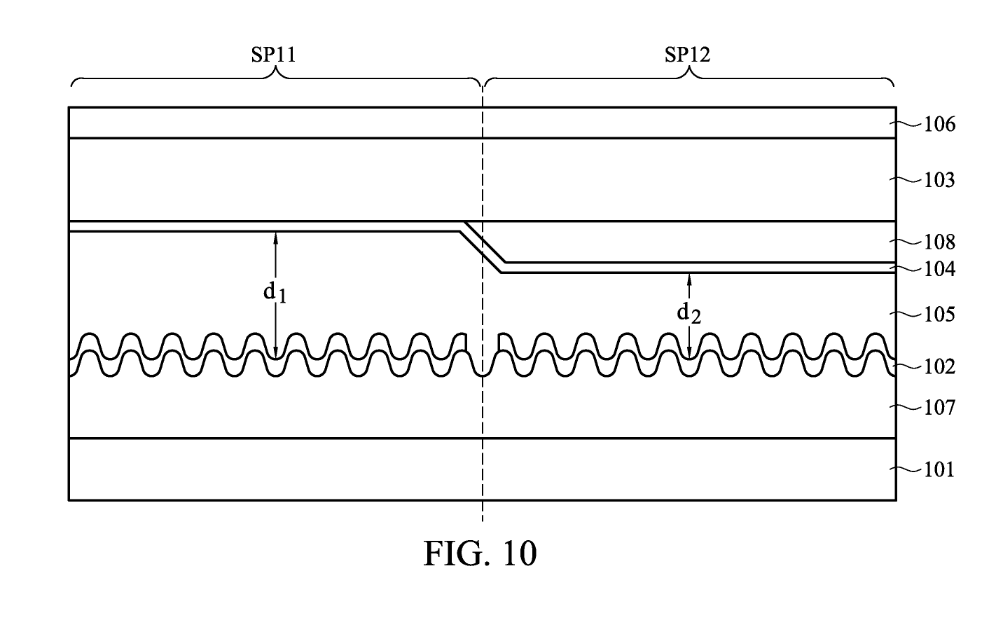

FIG. 10 is a plane view of the pixel structure of the pixel circuit shown in FIG. 9.

The pixel comprises a first transparent substrate where a pixel electrode 102 is formed, a second transparent substrate 103 where an opposite electrode 104 opposite to the pixel electrode 102 is formed, a liquid crystal layer 105 formed by injecting liquid crystal into the space between the first transparent substrate 101 and the second transparent substrate 103, and a polarizer 106 formed on the second transparent substrate 103. The pixel electrode 102 is formed on a transparent resin layer 107 disposed on the first transparent substrate 101. In this example, the pixel electrode 102 also functions as a reflector to reflect ambient light incident to the pixel structure through the second transparent substrate 103. Thus, the opposite electrode 104 is a light-passable transparent electrode. The opposite electrode 104 is formed on a transparent resin layer 108 disposed on the second transparent substrate 103.

The region of the pixel is divided into two pixels SP11 and SP12. The thickness of the transparent resin layer 108 should be determined appropriately such that the distance between the pixel electrode 102 and the opposite electrode 104 (the distance is usually called a cell gap) is different in the subpixel SP11 and the subpixel SP12. In the color liquid crystal display device using the characteristic of a birefringence of a liquid crystal molecule, the pixel cannot only display different colors in response to different voltages applied to the pixel electrode, but also display different colors in response to different cell gaps under the situation where the same voltage is applied.

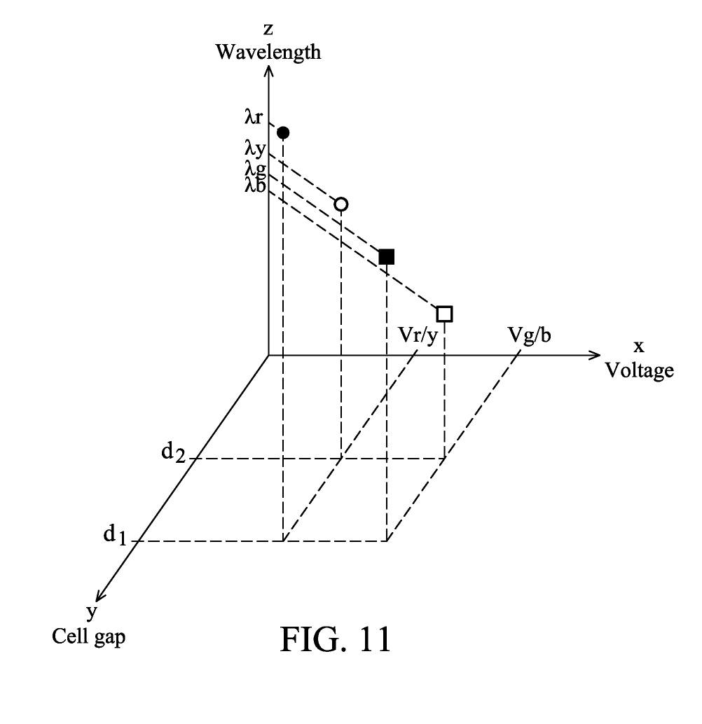

FIG. 11 is a diagram showing the relations among the voltage applied to the pixel electrode, the cell gap, and the wavelength of the color displayed by the pixel.

In this example, assuming that the cell gap of the first subpixel SP11 is d₁ and the cell gap of the second subpixel SP12 is d₂, wherein d₁>d₂. When the pixel electrode 102 is applied with a voltage Vr/y, the first subpixel SP11 displays light with wavelength λr and the second subpixel SP12 displays light with wavelength λy. When the pixel electrode 102 is applied with a voltage Vg/b, the first subpixel SP11 displays light with wavelength λg and the second subpixel SP12 displays light with wavelength λb. Specifically, wavelengths λr, λg, λb, and λy correspond to red, green, blue, and yellow light, wherein Vg/b>Vr/y.

As described above, by determining the voltage applied to the pixel electrode and the cell gap appropriately, one voltage supply line can be shared for a plurality of color components, as the pixel circuit shown in FIG. 9 does. Namely, in the case where a pixel is divided into a plurality of subpixels, in comparison with the pixel circuit shown in FIG. 5, the pixel circuit shown in FIG. 9 can further improve aperture and support displays with higher resolution by determining the cell gap of each subpixel appropriately.

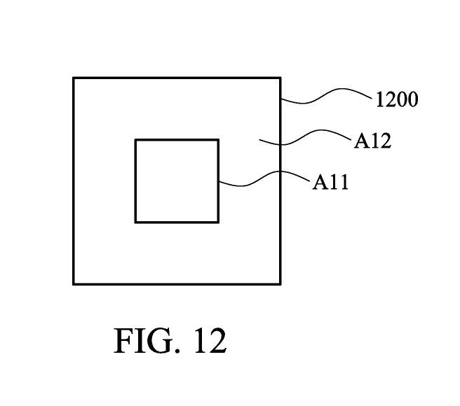

FIG. 12 is a plane view of a pixel structure in the display device in accordance with an embodiment of the invention.

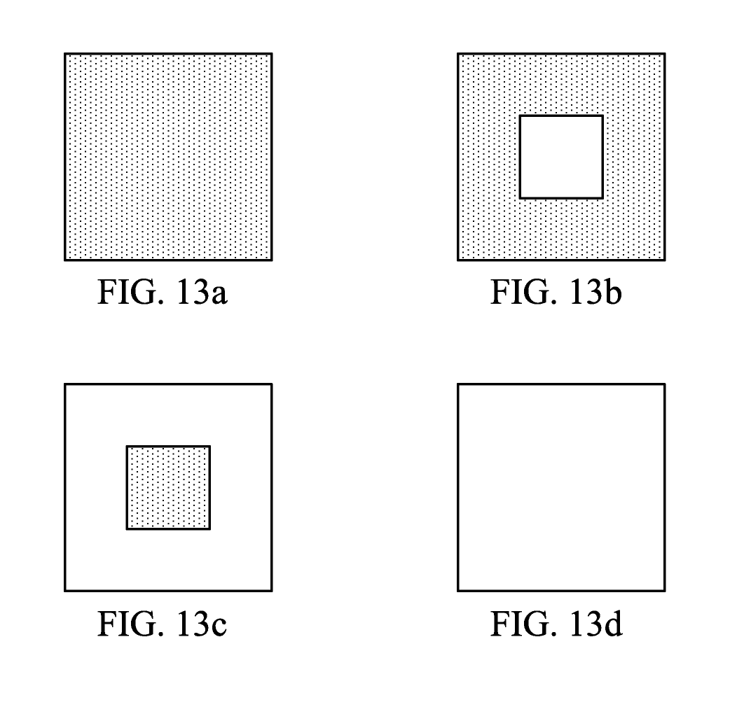

A pixel 1200 shown in FIG. 12 is divided into 2 regions A11 and A12. The first region A11 is surrounded by the second region A12. The first region A11 and the first region A12 both have an identical pixel circuit as shown in FIG. 3. In this structure, when the two pixel circuits are controlled to display an identical color, 4 gray levels can be generated in response to enable/disenable of each pixel circuit, as shown in FIGS. 13a˜13d. The enable/disenable of a pixel circuit can be controlled by the controller 15.

A lowest gray level is displayed if the pixel circuits of the first and second regions A11 and A12 of the pixel are disenabled (FIG. 13a). A highest gray level is displayed if the pixel circuits of the first and second regions A11 and A12 of the pixel are enabled (FIG. 13d). Middle gray levels are displayed if only one of the pixel circuits of the first and second regions A11 and A12 of the pixel is disenabled (FIG. 13b and FIG. 13c).

As described above, dividing a pixel to achieve gray levels can also be applied to the case where a pixel is divided into above 2 subpixels to perform multicolor. For example, when a pixel is divided into 2 subpixels as shown in FIG. 5, the 2 subpixels can be further divided into above 2 regions, wherein each subpixel is embedded with an identical circuit. Thus, multi gray levels can also be achieved.

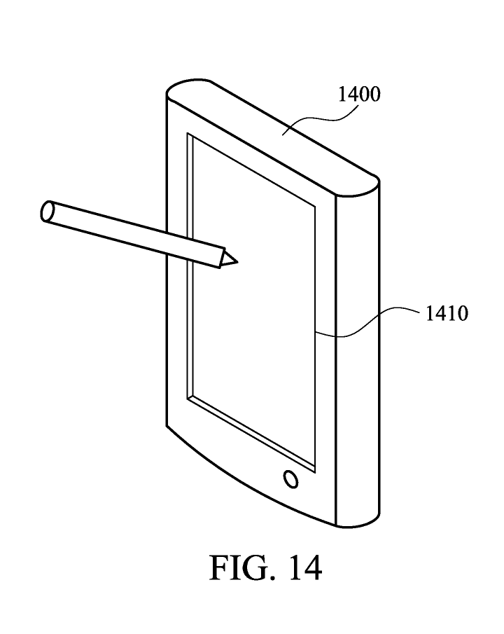

FIG. 14 is an example showing an electronic device provided with a display device in accordance with an embodiment of the invention. The electronic device 1400 in FIG. 14 is represented by a tablet computer, but other electronic devices such as a television, a laptop computer, a desktop computer, a cell phone, a digital camera, a PDA, a car navigation device, a portable game device, an AURORA VISION, or etc. is also suitable for the invention.

The tablet computer 1400 is provided with a display device 1410. The display device 1410 can be a display panel for showing information by displaying images. The display device 1410 can be any one of the color liquid crystal display device shown in FIGS. 1-13. In this regard, because the display panel 1410 can assure high transmittance or reflectance and display multicolor stably with low power consumption, the display device 1410 is suitable for devices, such as electronic books which display the same image during a certain period.

In summary, the liquid crystal display device of the invention combines the MIP technique and the color display technique based on a optical retardation characteristic, so that high transmittance or reflectance can be assured and multicolor can be displayed stably.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art).

For example, by using the same method as described in FIGS. 4-8, above two adjacent pixels can be regarded as a group to display a color by mixing colors displayed by the above two adjacent pixels.

What is claimed is:

1. A liquid crystal device, provided with a plurality of pixels arranged in a matrix, wherein each pixel comprises:
a memory circuit storing digital values representing a color to be displayed by the pixel;
a digital-analog converter circuit converting the digital values stored in the memory circuit to a voltage corresponding to the color to be displayed; and
a liquid crystal cell transmitting light with different wavelengths according to the voltage.

2. The liquid crystal device as claimed in claim 1, further comprising:
a voltage source providing each pixel with the voltage corresponding to the color to be displayed by the pixel.

3. The liquid crystal device as claimed in claim 2, wherein the voltage source comprises a plurality of voltage supply lines corresponding to each of a plurality of colors.

4. The liquid crystal device as claimed in claim 3, wherein the plurality of colors comprises RGB colors.

5. The liquid crystal device as claimed in claim 1, wherein each pixel has above 2 subpixels, and the memory circuit, the digital-analog converter circuit, and the liquid crystal cell are disposed in each subpixel.

6. The liquid crystal device as claimed in claim 5, wherein each pixel has 3 subpixels, and the digital-analog converter circuits of the 3 subpixels output voltages corresponding RGB colors, respectively.

7. The liquid crystal device as claimed in claim 5, wherein the pixel has 2 subpixels, and
wherein the digital-analog converter circuit of the first subpixel outputs voltages corresponding to any two colors of the RGB colors, and the digital-analog converter circuit of the second subpixel outputs voltages corresponding a color mixed from the two colors and the other color of the RGB colors.

8. The liquid crystal device as claimed in claim 1, wherein each pixel has 2 subpixels, and the liquid crystal cell is disposed in each subpixel but the memory circuit and the digital-analog converter circuit is shared by the 2 subpixels, and
wherein the digital-analog converter circuit outputs voltages corresponding to any two colors of the RGB colors to one of the liquid crystal cells, and outputs a voltage corresponding the other color of the RGB colors to the other liquid crystal cell.

9. The liquid crystal device as claimed in claim 1, wherein in a group formed by two adjacent pixels, the digital-analog converter circuit of one of the two pixels outputs voltages corresponding to any two colors of the RGB colors, and the digital-analog converter circuit of the other one of the two pixels outputs a voltage corresponding the other color of the RGB colors.

10. The liquid crystal device as claimed in claim 5, wherein the liquid cells of the subpixels have different cell gaps, and when applied with the same voltage the liquid cells with different cell gaps transmit light with different wavelengths.

11. The liquid crystal device as claimed in claim 1, wherein each pixel is divided into above 2 regions with the same structures, and the above 2 regions are enabled or disenabled.

12. The liquid crystal device as claimed in claim 1, wherein the memory circuit has an SRAM or a DRAM.

13. An electronic device, comprising the liquid crystal device as claimed in claim 1.
